(19) United States
(12) Patent Application Publication
(10) Pub. No.: US 2010/0304097 A1
(43) Pub. Date: Dec. 2, 2010

(54) Internally supported modular and non-modular linked structures

(76) Inventors: Scott Brian Nokleby, Oshawa (CA); Remon Pop-Iliev, Mississauga (CA)

Correspondence Address: DOWELL & DOWELL P.C., 103 Oronoco St., Suite 220, Alexandria, VA, 22314, US

(21) Appl. No.: 12/453,940

(22) Filed: May 27, 2009

(51) Int. Cl. B32B 3/10; B29C 45/14; B32B 37/00; B32B 9/04; B32B 15/08

(52) U.S. Cl. 428/195.1; 264/229; 264/101; 264/139; 264/259; 428/411.1; 428/457

(57) ABSTRACT

A method of fabricating reinforced modular and non-modular composite members having a predetermined cross sectional shape, comprising the steps of: providing a source of composite material; selecting a plurality of cross-sectional shapes for the components of the composite member, whereby the components are arrangable to form the predetermined cross sectional shape of the composite member; applying the composite material on each of a plurality of mandrels; curing the composite material to form a plurality of components; attaching a pre-stressing device to at least one of the plurality of components and pre-stressing said component to produce at least one pre-stressed component; arranging the components to form an assembly of the components in the predetermined cross sectional shape of the composite member, wherein the assembly includes the at least one pre-stressed component; applying the composite material to the assembly of components; curing the composite material; and releasing the pre-stressing device.

### FIELD OF THE INVENTION

This invention relates to linked structures and in particular internally supported linked structures. More specifically, this invention relates to, but is not limited to, providing a design solution that overcomes the heavy weight of robot structures that are expected to handle heavy payloads with high speeds through complex spatial trajectories at a long reach while preserving high positional accuracy and dynamic performance, by applying composite materials to robot structures. In addition, this invention is readily applicable to the design of lightweight structural beams for a wide variety of industrial and civil applications that are characterized by high stiffness/strength to weight ratios.

### BACKGROUND OF THE INVENTION

Industrial applications increasingly involve highly automated high-speed and high payload operations involving robotic architectures that have to fulfill complex spatial movements of their end effectors. This is often accompanied with the need for robotic structures that possess relatively long reach, high positional accuracy, and outstanding dynamic performance. To fulfill these demands, the structure of the robot has to be designed so as to have both high specific stiffness and high damping ability. However, increasing the thickness and the overall size of a robotic structure to achieve enhanced stiffness is not a viable option because of the resulting increase in the mass and inertia of the robot, which directly imposes the implementation of more powerful, and thus heavier, motors to achieve identical acceleration, which adds even more weight to the overall system. Consequently, the problem translates to the nontrivial task of increasing the stiffness of the robotic structure without increasing its weight. Regrettably, other than in reduced or near zero-gravity settings in space, aluminum or titanium cannot be considered as adequate substitutes for steel in this context since their specific stiffness is no higher than that of steel. Therefore, increasing the stiffness without simultaneously increasing the weight of the robot structure in terrestrial full gravity settings is not possible with conventional materials. Instead, composite materials provide a feasible solution. The rationale behind this design direction is the fact that the currently available high-modulus carbon-fiber epoxy composites possess favourable properties such as a specific stiffness about ten times as high as that of conventional metals in addition to a high specific strength, high damping, and low coefficient of thermal expansion.

The prior art can be divided into three broad groups of patent disclosures. The first group consists of inventions related to the use of the filament winding technique on a pole/core/cylindrical article. It includes the following patents: U.S. Pat. No. 2,785,442, U.S. Pat. No. 3,429,758, U.S. Pat. No. 4,878,984, U.S. Pat. No. 4,118,814, U.S. Pat. No. 4,512,835, U.S. Pat. No. 5,609,349, U.S. Pat. No. 5,238,716 and U.S. Pat. No. 6,367,225. Among these, U.S. Pat. No. 2,785,442, U.S. Pat. No. 3,429,758, and U.S. Pat. No. 4,878,984 describe a method/apparatus for the filament winding technique. U.S. Pat. No. 2,785,442 and U.S. Pat. No. 3,429,758 involve winding layers of fibers with opposing angles around a mold. U.S. Pat. No. 3,429,758 surrounds the layers of fibers with foam and concludes with a final layer of transparent plastic for improved aesthetics and weathering characteristics. U.S. Pat. No. 4,878,984 describes a filament winding machine that utilizes a parallelogram mechanism to apply a plurality of equally spaced parallel fiber slivers. By expanding the parallelogram, the distance between slivers and the angle can be altered which leads to a varying wall thickness. This can be utilized to create a taper. U.S. Pat. No. 4,118,814, U.S. Pat. No. 4,512,835, U.S. Pat. No. 5,609,349, U.S. Pat. No. 5,238,716 and U.S. Pat. No. 6,367,225 discuss products that are created using the filament winding technique. U.S. Pat. No. 4,118,814, U.S. Pat. No. 4,512,835, and U.S. Pat. No. 5,609,349 introduce a product that is created by cutting a part that is filament wound. U.S. Pat. No. 5,609,349 utilizes a diamond blade circular saw to cut the part and ensure that the strength of the component is not compromised. U.S. Pat. No. 5,238,716 introduces a long hollow composite beam intended to serve as a lightweight high strength beam for boom trucks with a rectangular shape. It is produced by filament winding an interior layer and then placing four previously made unidirectional fiber plates around the interior layer and then winding an exterior layer. The advantage of using the pre-made plates is that it enables the beam to be made with a non-uniform thickness in order to improve its compressive and tensile strength. U.S. Pat. No. 6,367,225 describes a filament wound light pole that is 20 feet long and can support a 300 pound force at its opposite end without exceeding a deflection of 20 inches. In order to successfully do so, the light pole is constructed to include a taper. The tension in the tow thread during the filament winding process is between 30 and 100 pounds, and the pole is made to include multiple layers in which the interior and exterior circumferential layers surround a layer of helical wound fibers.

The second group consists of patents U.S. Pat. No. 3,544,417, U.S. Pat. No. 3,339,326, U.S. Pat. No. 3,181,187 and U.S. Pat. No. 1,141,067. These patents discuss methods of reinforcement for support structures made of modular units of any shape made up of composite materials/light metal that are used for load bearing/supporting purposes. U.S. Pat. No. 3,544,417, U.S. Pat. No. 3,339,326 and U.S. Pat. No. 3,181,187 describe a support structure in which a series of elongated members are arranged to provide the support. The interlocking members have a hollow triangular cross-section in order to create a lightweight and strong structure. The support structures described in the first two patents also fill the hollow members with foam to improve the strength to weight ratio. The methods for creating the two support structures differ however in that the foam core is first made and then the fiberglass fabric is wrapped around it for the first patent but for the second patent the elongated member is first made and then filled with foam. U.S. Pat. No. 1,141,067 describes a method for reinforcing a tube. An initially hollow tube is filled with a series of identical segments to create a hollow tube with an internal support system.

The third group of patents and a statutory invention registration includes U.S. Pat. No. 6,044,607, U.S. Pat. No. 6,081,955, USH1872, U.S. Pat. No. 3,779,487, U.S. Pat. No. 4,223,053, and U.S. Pat. No. 6,655,633. These patents discuss modular units made up of composite materials for load bearing/supporting purpose. The support structures defined in the aforementioned patents consist of modular elongated members that are designed to be hollow in order to keep the weight and cost to a minimum while still providing enough strength. All these patents, however, describe a support system that is made up of a series of elongated members that are attached together to form a support system. The modular units of these patents are considerably long, in the range of 20 feet. Additionally, the cross-sectional geometries have a variety of shapes ranging from triangular to circular and including variations of these simple shapes. The units are sandwiched between an upper and lower layer that contacts all of the elongated members to form truss core panels comprising face sheets and a core. These layers transfer the applied forces to the members that then in turn support the load. U.S. Pat. No. 6,044,607 and U.S. Pat. No. 6,081,955 describe modular support structures made of a composite material produced using hand or automatic lay-up, whereas USH1872, U.S. Pat. No. 3,779,487, U.S. Pat. No. 4,223,053, and U.S. Pat. No. 6,655,633 describe a support structure that is produced using filament winding. In the statutory invention registration USH1872, the individual modular units are attached by assembling them in the proper orientation and applying a resin and curing it. The modular fiber reinforced bridge described in USH1872 bonds the individual modular units by first assembling them and then filament winding around the collection of the individual units. This method is beneficial because it provides a stronger bond and only adds extra time for properly setting up the filament winding machine as it is adding necessary layers of fiber to the product.

Accordingly, it would be advantageous to provide an internally supported structure that has at least one internal pre-stressed component. Further, it would be advantageous to provide an internally supported structure that has a multi-layered outer-shell wherein the layers have different orientations. Further it would be advantageous to provide an internally supported structure that is lighter weight than conventional structures.

### SUMMARY OF THE INVENTION

A method of fabricating reinforced composite members having a predetermined cross sectional shape and each member having internal components, the method includes the steps of: providing a source of composite material; selecting a plurality of cross-sectional shapes for the components of the composite member, whereby the components are arrangable to form the predetermined cross sectional shape of the composite member; applying the composite material on each of a plurality of mandrels, the mandrels corresponding to the selected plurality of cross-sectional shapes; curing the composite material to form a plurality of components; attaching a pre-stressing device to at least one of the plurality of components and pre-stressing said component to produce at least one pre-stressed component; arranging the components to form an assembly of the components in the predetermined cross sectional shape of the composite member, wherein the assembly includes at least one pre-stressed component; applying the composite material to the assembly of components; curing the composite material applied to the assembly of components; and releasing the pre-stressing device.

In another aspect of the invention there is provided a method of fabricating reinforced composite members having a predetermined cross sectional shape and each member having internal components. The method includes the steps of: providing a source of composite material; selecting a plurality of cross-sectional shapes for the components of the composite member, whereby the components are arrangable to form the predetermined cross sectional shape of the composite member; providing the components corresponding to the selected cross-sectional shapes; arranging the components to form an assembly of the components in the predetermined cross sectional shape of the composite member; applying the composite material to the assembly of components whereby the composite material is applied to the assembly of components in a plurality of layers and each of the plurality of layers has an orientation and wherein at least one of the layers has a different orientation from an adjacent layer; and curing the composite material.

In a further aspect of the invention there is provided a method of fabricating reinforced composite members having a predetermined cross sectional shape and each member having internal components. The method includes the steps of: providing a source of composite material; selecting a plurality of cross-sectional shapes for the components of the composite member, whereby the components are arrangable to form the predetermined cross sectional shape of the composite member and when arrange provide internal support; providing the components corresponding to the selected cross-sectional shapes; arranging the components to form an assembly of the components in the predetermined cross sectional shape of the composite member; applying the composite material around the assembly of components; and curing the composite material.

Another aspect of the invention is directed to an internally supported composite member which includes a plurality of components having cross-sectional shapes arranged to form a predetermined cross sectional shape of the composite member, wherein at least one of the plurality of components is pre-stressed; and an outer-shell of composite material.

A still further aspect of the invention is directed to an internally supported composite member which includes an internal component having a predetermined cross section; and an outer-shell of composite material having a plurality of layers and each of the plurality of layers has an orientation and wherein at least one of the layers has a different orientation from an adjacent layer.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a 3-dimensional view showing one embodiment of an internally supported linked structure of the present invention;

FIG. 21) to 16) show cross sectional views of alternate embodiments of internally supported linked structures of the present invention;

FIG. 3 is a 3-dimensional view of four segments used to create an embodiment of an internally supported linked structure.

FIG. 4 is a 3-dimensional view of an embodiment of the present invention wherein all sides are tapered;

FIG. 5 is a 3-dimensional view of one embodiment of a mandrel that may be used with the four components shown in FIG. 3 and is for use in winding the outer surface link of an internally supported linked structure;

FIG. 6 is a front view of a specialized winding pattern that may be used with the internally supported linked structure of the present invention;

FIG. 7 is a front view of an alternate specialized winding pattern forming a diamond-shaped pattern that may be used with the internally supported linked structure of the present invention;

FIG. 8 is a cross-sectional view of an internal support structure;

FIG. 9 is a side view of the internal support structure of FIG. 5;

FIG. 10 is a cross-sectional view of segments used for an alternate internal support structure;

FIG. 11 is a cross sectional view of a foam filled embodiment of an internally supported linked structure of the present invention;

FIG. 12 is a schematic view of a six degree of freedom robot arm constructed from the internally supported structure of the present invention;

FIG. 13 is a perspective view of an internally supported structure in the shape of an I beam; and

FIG. 14 is a cross sectional view of the internally supported structure shown in FIG. 13.

### DETAILED DESCRIPTION OF THE INVENTION

Prior art link structures have hollow cross-sections. However, in the embodiments shown herein there are provided links built out of composite materials having an internal support structure made out of composite materials, plastic, or metal to increase the stiffness of the structure while minimizing the weight. In some of the embodiments, as a way to increase the load capacity of these members, the internal support structure is pre-stressed with the final outer layers of composite material holding the pre-stress in place. Preferably the composite material is fiber reinforced polymer-matrix, fiber reinforced metal polymer composite or nano-composite.

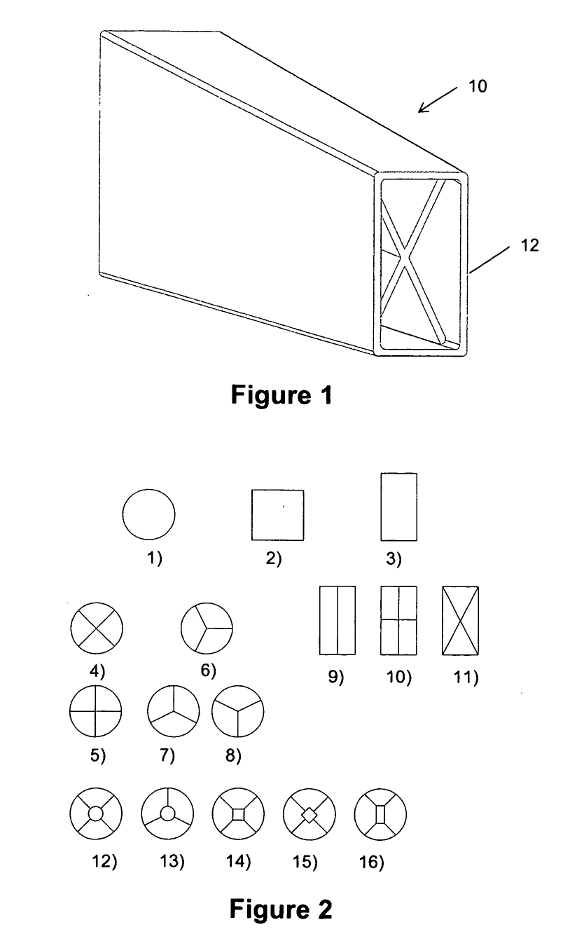

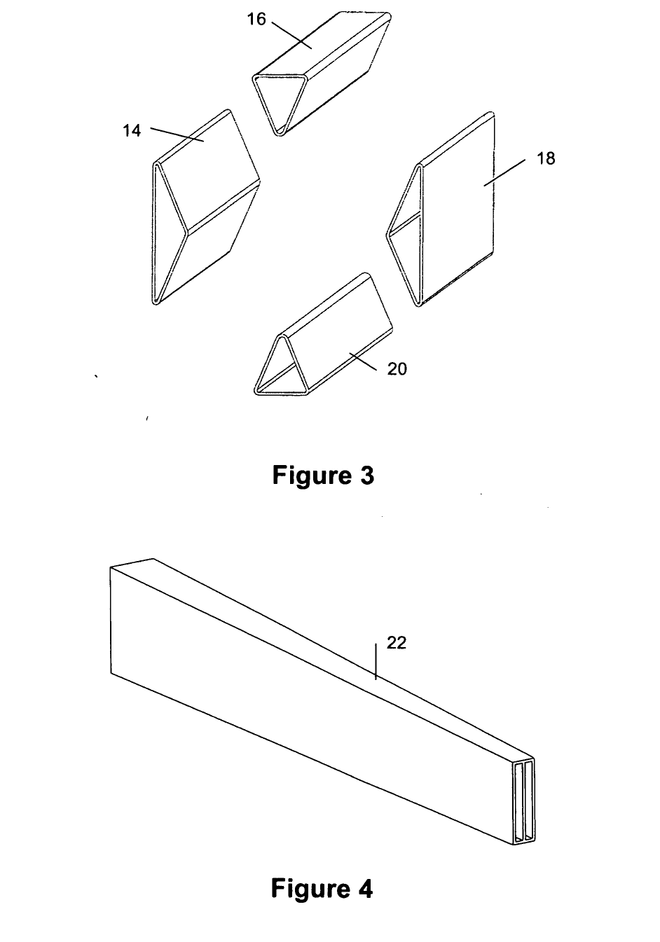

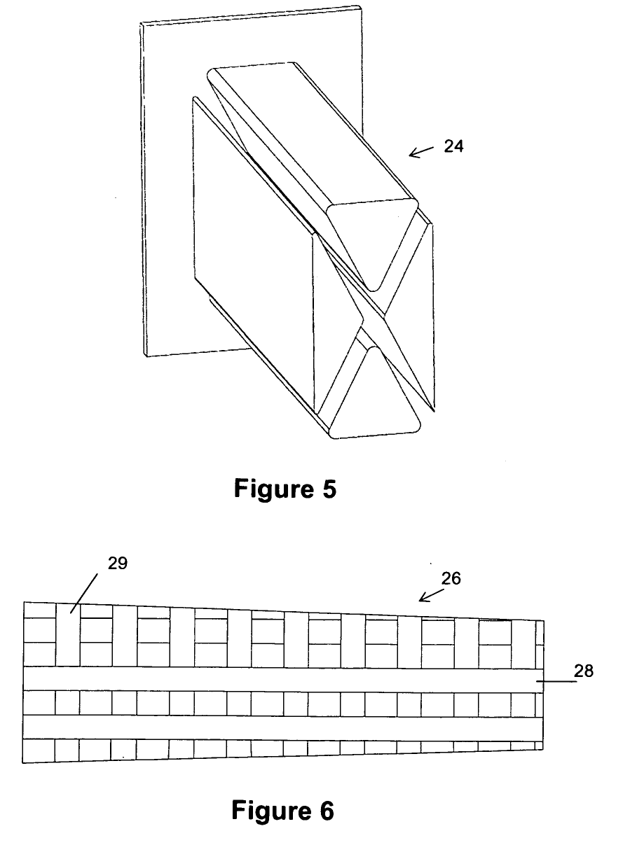

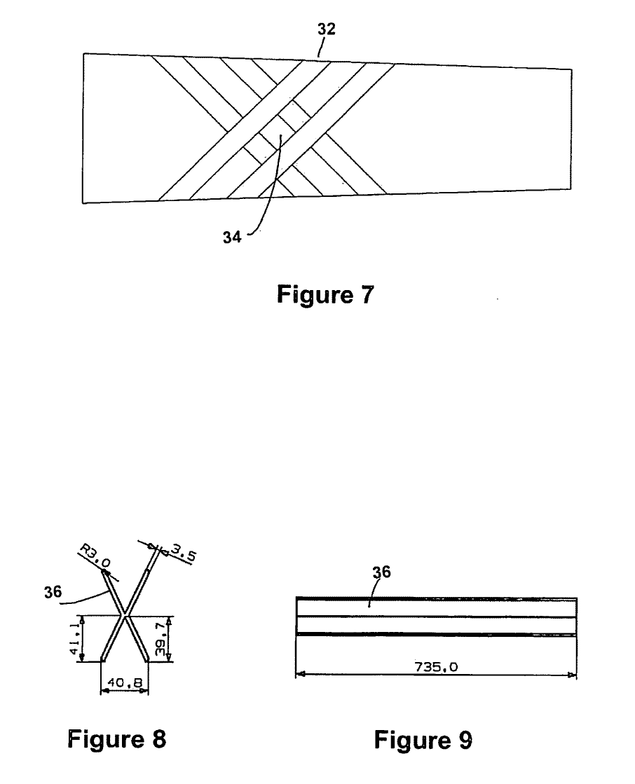

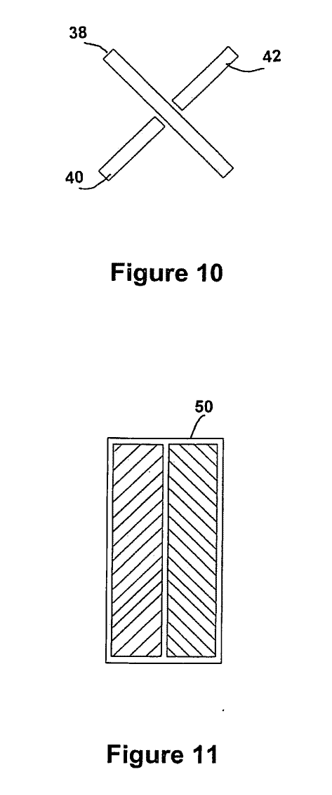

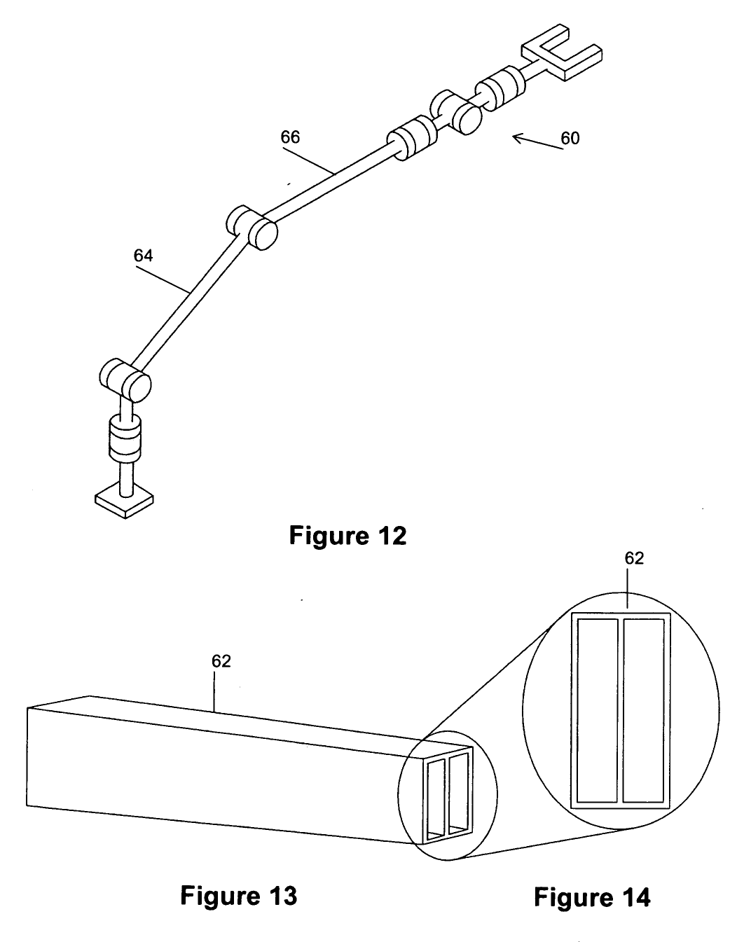

FIG. 1 shows an embodiment of an internally supported rectangular composite link structure 10 featuring an X-shaped cross-section 12. The internal support structure can be a variety of shapes ranging from beams to X's to crosses as shown in FIG. 2. The outer cross-sectional profile can be any shape, including circular as shown in 1), oval, square as shown in 2), and rectangular as shown in 3). The internal support structure can have a variety of different configurations, some examples of which are shown in FIG. 2 items 4) to 16). Some examples of internal supports for a circular tube are an X-support with the force between two ribs as shown in 4) or a force parallel to two ribs 5). Alternatively, a tri-support with the force perpendicular to one rib 6), a force parallel to one rib 7) or a force between two ribs 8). The tube could also have an inner tube as shown in FIG. 2 items 12) to 16), namely an X-supported annulus 12), a tri-supported annulus 13), an X-supported square 14), an X-supported diamond 15) and an X-supported rectangle 16). Some alternative rectangular tubes with support ribs are shown in FIG. 2 items 9) to 11), namely an I-beam 9), a T-support 10) and an X-support 11). As will be appreciated by those skilled in the art that there are a wide variety of possible configurations for an internally supported linked structure and those shown in FIG. 2 are by way of example only.

The internal support structure can be made up in a modular fashion or in a non-modular fashion. The two methods are described below.

If the modular construction system is used, then a plurality of modular composite individual pre-cured or non-pre-cured filament/ribbon wound simple cross-sections (triangles, squares, etc.) are made. The components may be cured in an atmospheric pressure environment or a vacuum environment. Multiple lengths of the simple cross-sections are joined using adhesive bonding to form the overall cross-section embodying the internally supported linked structure. These modular elements may then be pre-stressed using mechanical means. The outer-shell of the profile is composite filament/ribbon wound around the composite modules comprising the internal support structure to hold the pre-stress. Once cured, the device applying the pre-stress to the internal support structure, if present, is removed.

To further illustrate the concept, the steps to make a modular constructed internally supported pre-stressed composite link structure are outlined below. The composite link featuring an X-shaped support shown in FIG. 1 will be used as an example.

The composite link is split up into a combination of simple closed cross-section links. For example, the X-supported rectangular link can be divided into four triangular components or links 14, 16, 18 and 20 as illustrated in FIG. 3.

Considering the components 14, 16, 18 and 20 are all simple closed cross section hollow parts. Filament winding is preferred for the construction of the components 14, 16, 18 and 20. However, hand lay-up could also be used. Each unique component is made separately and thus requiring a unique mandrel. The mandrel is used to wind the fibers thereon. Sacrificial loss foam molds or permanent molds may be used as the mandrels. For the X-supported rectangular link, shown in FIG. 3, due to its symmetry, the interior support structure is composed of only two unique triangles. Specifically components 14 and 18 could use the same mandrel and components 16 and 20 could use the same mandrel. Consequently, it would only require two different mandrels to produce the two unique triangular links. To reduce manufacturing time, components with identical geometries can be wound as one long component and then cut to the necessary size. After each component is wound, the mandrels and parts are placed, individually or collectively oven-permitting, in an oven and the resin is cured. Upon curing, the resulting parts are removed from the respective mandrel. Optionally, the modules can be tapered for structural reasons and thus will have to be produced separately for each desired length. An example of a tapered I-beam is shown in FIG. 4 at 22.

Once all the individual components have been wound and cured, they are “pre-assembled” by following a profile-dependent suitable arrangement (see FIG. 2). An epoxy and external pressure is applied onto the external surfaces of contact between all the components to create a permanent bond and thereby actually forming a self-supported final mandrel themselves after the adhesive has cured. The entire assembly may then be pre-stressed using a mechanical pre-stressing mechanism. Then the final winding process can take place.

For this processing step, the pre-assembled components (which is actually the final mandrel) is held on each end of the winding machine by using end-components designed for the profile being used. An example of an end component 24 is shown in FIG. 5 and is designed to accommodate the composite link structure as presented in FIG. 1 along with a pre-stressing mechanism (not shown). A non-stick material is applied onto the mandrel end-components to help facilitate removal of the mandrel after curing. The resin coated fibers are then wound around the exterior of all the components to form a single link. The winding pattern of the outside may be done in such a manner to achieve specialized patterns to increase the strength and decrease the weight. For example the winding pattern may have a plurality of layers and each of the plurality of layers has an orientation and at least one of the layers has a different orientation from an adjacent layer. Accordingly the orientation of the windings may be determined in light of the particular use of the member. A checker board pattern may be used as shown in FIG. 6 at 26 wherein the windings are oriented along the longitudinal axis 28 and along the lateral axis 29. Alternatively, the fiber may be wound to form a diamond pattern 32 as shown in FIG. 7. The fiber may be wound such that one or a plurality of regions on the components having no layers 34. To further reduce the weight of the member, the component may have a hole formed therein in registration with region 34.

After it is wound to the desired thickness and shape, the mandrel end-components and the link are set in an oven and heated to cure the resin. After it has been sufficiently heated, the link is removed from the holding end-components, the pre-stressing mechanism if present is removed, and the final product remains.

Unlike the modular construction method above, the internal support can also be built as its own monolithic structure first. For this method, the internal support structure would either be laid-up by hand or extruded. The internal support structure could either be a straight profile or it could be spiraled. The internal structure is then pre-stressed using mechanical means. The outer-shell of the profile is either pre-cured or non-pre-cured composite filament/ribbon wound around the internal support structure to hold the pre-stress. Once cured, the device applying the pre-stress to the internal support structure is removed.

To further illustrate this concept, the steps to make an internally supported pre-stressed composite link structure are outlined below. The composite link featuring an X-shaped support shown in FIG. 1 will be used as an example.

The interior support structure 36 as shown in FIGS. 8 and 9 is first constructed. The component can be constructed using either extrusion or hand lay-up.

If extrusion is used to produce the interior support structure, then a die of the desired profile shape is needed. It is a very quick process that requires one stage curing of the part after the polymer composite material has been extruded through the die. Note that the internal support structure could also be made of plastic or metal that has been extruded.

If the hand lay-up process is used, a negative mold is needed. For interior support structures with a complicated shape it may be necessary to build different sections separately. As an example, for the X-shaped support structure 36 it may be easier to construct the segments as shown in FIG. 10. For this process, the X-structure 36 would be built from three pieces 38, 40, 42 that are bonded or welded together. If using this technique, it would be necessary to cure the resin after every part is constructed. Therefore, for the X-shaped internal support multiple curing stages would be required. Although the hand lay-up process may be more time consuming compared to the extrusion method, it allows the fibers to be oriented in any direction, which would not be possible if extrusion is used. As above, the internal support structure 36 could also be made of plastic or metal.

Optionally, tapered internal support structures that will ultimately result in tapered links can be also produced.

Before final assembly, the internal support structure may be pre-stressed using a mechanical pre-stressing mechanism. Since the exterior structure of the link fully encloses the interior support structure, the filament winding process is to be used to construct it (note that hand lay-up could also be used). Filament winding is very well suited to polymer composites because it provides the greatest amount of control of fiber orientation and placement. After the interior support structure is constructed, the exterior of the link is constructed on top of the internal structure that simultaneously acts as a mandrel.

The pre-produced internal structure (which is actually the final mandrel) is held on each end of the winding machine by end-component 24 shown in FIG. 5. End components 24 are designed to accommodate the internal support structure 36 along with the pre-stressing mechanism (not shown). To facilitate permanent bonding of the exterior structure to the interior support structure, the exterior support structure is wound directly onto the interior support structure. An epoxy is brushed onto the interior support structure at the contact points between the two components to create a permanent bond. To ensure that the material does not bow between the locations where the interior and exterior structures contact each other during the winding process, a removable mandrel may be used.

A non-stick material is applied onto the mandrel end-components to help facilitate removal of the mandrel after curing. The above process allows the interior support structure to be placed anywhere along the length of the future exterior profile of the finally assembled link. For example, the internal structure could exist throughout the entire length of the future finally assembled link, or it could be excluded from the initial portions of the future finally assembled link on one or both its sides (see FIG. 1). The resin coated fibers are then wound around the exterior of all the components to form a single link. The winding pattern of the outside can be done in such a manner to achieve specialized patterns to ensure maximum strength and minimal weight. For example, the fiber can be wound to form a checker-board or diamond-shaped pattern.

After it is wound to the desired thickness, the mandrel end-components 24 and component are set in an oven and heated to cure the resin. After it has been sufficiently heated, the link is removed from the holding end-components, the pre-stressing mechanism is removed, if present, and the final product remains.

In addition to the support structure, one or more portions of the cross section could be filled with a foam material to provide additional strength while remaining lightweight, or produced entirely as an integral skin foam-reinforced cellular composite. An example of an internally supported structure with a foamed core is shown in FIG. 11 at 50.

By pre-stressing the internal members, the overall assembly can handle increased loading that an equivalent sized system without pre-stressing cannot withstand. Therefore, for a required load capability, a pre-stressed system can be made smaller and lighter than a non-pre-stressed system. In addition to the weight and size advantages, such a system would require less material to construct, thus reducing manufacturing costs.

The internally supported composite structures may be used in a wide variety of applications. For example they may be used in robotics applications. FIG. 12 shows a schematic of a 6-DOF (degree-of-freedom) robot arm at 60. FIGS. 13 and 14 show an example of an I-beam robot link or component 62 that has been designed to be used for the two main-arm links 64 and 66 in FIG. 12.

The use of the internal structure along with the composite material provides a very strongly designed structural member that has high stiffness and minimal deflection when loaded. The link is considerably lighter than a traditional link built from metals such as aluminum or steel.

Although the application shown for the invention is as a link design for robot arms, the proposed invention can be used in a variety of different applications that require long links that feature high stiffness-to-weight ratios.

The proposed invention could be used to build the booms of cherry-pickers, cranes, and other systems that have loads suspended a long distance from their base. The invention could also be used to build light-weight, high-strength bumpers for automobiles and trucks. Beams used in construction projects could be created using this invention. The masts and arms of sailing ships could also be built using this invention. The range of applications is almost limitless.

Generally speaking, the systems described herein are directed to internally supported linked structures. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to internally supported linked structures.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

What is claimed as the invention is:

1. A method of fabricating reinforced composite members having a predetermined cross sectional shape and each member having internal components, comprising the steps of:
providing a source of composite material;
selecting a plurality of cross-sectional shapes for the components of the composite member, whereby the components are arrangable to form the predetermined cross sectional shape of the composite member;
applying the composite material on each of a plurality of mandrels, the mandrels corresponding to the selected plurality of cross-sectional shapes;
curing the composite material to form a plurality of components;
attaching a pre-stressing device to at least one of the plurality of components and pre-stressing said component to produce at least one pre-stressed component;
arranging the components to form an assembly of the components in the predetermined cross sectional shape of the composite member, wherein the assembly includes the at least one pre-stressed component;
applying the composite material to the assembly of components;
curing the composite material applied to the assembly of components; and
releasing the pre-stressing device.

2. The method of fabricating reinforced composite members as claimed in claim 1 wherein the attaching step includes attaching the pre-stressing device to all of the plurality of components.

3. The method of fabricating reinforced composite members as claimed in claim 2 wherein the composite material is chosen from a group consisting of fiber reinforced polymer-matrix, fiber reinforced metal polymer composite and nano-composite.

4. The method of fabricating reinforced composite members as claimed in claim 3 wherein the composite material is applied to the mandrel using one of a winding technique and a hand layup technique.

5. The method of fabricating reinforced composite members as claimed in claim 4 wherein the composite material is applied to the assembly using one of a winding technique and a hand layup technique.

6. The method of fabricating reinforced composite members as claimed in claim 5 wherein the plurality of mandrels are chosen from the group consisting of a sacrificial loss foam molds and permanent molds.

7. The method of fabricating reinforced composite members as claimed in claim 6 wherein the components are cured in one of an atmospheric pressure environment and a vacuum environment.

8. The method of fabricating reinforced composite members as claimed in claim 7 wherein composite material is applied to the assembly of components in a plurality of layers and each of the plurality of layers has an orientation and wherein at least one of the layers has a different orientation from an adjacent layer.

9. The method of fabricating reinforced composite members as claimed in claim 8 wherein the component has a longitudinal axis and a lateral axis and at least one of the layers is oriented along the longitudinal axis and at least one of the layers is oriented along the lateral axis.

10. The method of fabricating reinforced composite members as claimed in claim 8 wherein the plurality of layers produce a composite layered pattern and the composite layered pattern has a predetermined thickness, a predetermined strength and a predetermined weight.

11. The method of fabricating reinforced composite members as claimed in claim 10 wherein the plurality of layers are oriented whereby there is at least one region on the components having no layers.

12. The method of fabricating reinforced composite members as claimed in claim 11 further including the step of cutting out a portion of at least one of the components in registration with the at least one region having no layers thereon.

13. The method of fabricating reinforced composite members as claimed in claim 2 wherein composite material is applied to the assembly of components in a plurality of layers and each of the plurality of layers has an orientation and wherein at least one of the layers has a different orientation from an adjacent layer.

14. The method of fabricating reinforced composite members as claimed in claim 13 wherein the component has a longitudinal axis and a lateral axis and at least one of the layers is oriented along the longitudinal axis and at least one of the layers is oriented along the lateral axis.

15. The method of fabricating reinforced composite members as claimed in claim 13 wherein the plurality of layers produce a composite layered pattern and the composite layered pattern has a predetermined thickness, a predetermined strength and a predetermined weight.

16. The method of fabricating reinforced composite members as claimed in claim 15 wherein the plurality of layers are oriented whereby there is at least one region on the components having no layers.

17. The method of fabricating reinforced composite members as claimed in claim 16 further including the step of cutting out a portion of at least one of the components in registration with the at least one region having no layers thereon.

18. The method of fabricating reinforced composite members as claimed in claim 8 wherein the cross-sectional shapes of the components are chosen whereby when arranged to form the predetermined cross sectional shape provide internal support.

19. The method of fabricating reinforced composite members as claimed in claim 18 wherein the predetermined cross sectional shape is symmetrical around one of one axis and two axes.

20. The method of fabricating reinforced composite members as claimed in claim 13 wherein the cross-sectional shapes of the components are chosen whereby when arranged to form-the predetermined cross sectional shape provide internal support.

21. The method of fabricating reinforced composite members as claimed in claim 20 wherein the predetermined cross sectional shape is symmetrical around one of one axis and two axes.

22. A method of fabricating reinforced composite members having a predetermined cross sectional shape and each member having internal components, comprising the steps of:
providing a source of composite material;
selecting a plurality of cross-sectional shapes for the components of the composite member, whereby the components are arrangable to form the predetermined cross sectional shape of the composite member;
providing the components corresponding to the selected cross-sectional shapes;
arranging the components to form an assembly of the components in the predetermined cross sectional shape of the composite member;
applying the composite material to the assembly of components whereby the composite material is applied to the assembly of components in a plurality of layers and each of the plurality of layers has an orientation and wherein at least one of the layers has a different orientation from an adjacent layer; and
curing the composite material.

23. The method of fabricating reinforced composite members as claimed in claim 22 wherein the component has a longitudinal axis and a lateral axis and at least one of the layers is oriented along the longitudinal axis and at least one of the layers is oriented along the lateral axis.

24. The method of fabricating reinforced composite members as claimed in claim 22 wherein the plurality of layers produce a composite layered pattern and the composite layered pattern has a predetermined thickness, a predetermined strength and a predetermined weight.

25. The method of fabricating reinforced composite members as claimed in claim 24 wherein the plurality of layers are oriented whereby there is at least one region on the components having no layers.

26. The method of fabricating reinforced composite members as claimed in claim 25 further including the step of cutting out a portion of at least one of the components in registration with the at least one region having no layers thereon.

27. The method of fabricating reinforced composite members as claimed in claim 22 wherein the cross-sectional shapes of the components are chosen whereby when arranged to form the predetermined cross sectional shape provide internal support.

28. The method of fabricating reinforced composite members as claimed in claim 27 wherein the predetermined cross sectional shape is symmetrical around one of one axis and two axes.

29. The method of fabricating reinforced composite members as claimed in claim 22 wherein the components are one of hollow components and integral skin cellular core components.

30. The method of fabricating reinforced composite members as claimed in claim 29 wherein the composite material is chosen from a group consisting of fiber reinforced polymer-matrix, fiber reinforced metal polymer composite and nano-composite.

31. The method of fabricating reinforced composite members as claimed in claim 30 wherein the composite material is applied to the assembly using one of a winding technique and a hand layup technique.

32. The method of fabricating reinforced composite members as claimed in claim 22 wherein the components are made from one of plastic and metal.

33. A method of fabricating reinforced composite members having a predetermined cross sectional shape and each member having internal components, comprising the steps of:
providing a source of composite material;
selecting a plurality of cross-sectional shapes for the components of the composite member, whereby the components are arrangable to form the predetermined cross sectional shape of the composite member and when arranged provide internal support;
providing the components corresponding to the selected cross-sectional shapes;
arranging the components to form an assembly of the components in the predetermined cross sectional shape of the composite member;
applying the composite material around the assembly of components; and
curing the composite material.

34. The method of fabricating reinforced composite members as claimed in claim 33 wherein the predetermined cross sectional shape is symmetrical around one of one axis and two axes.

35. The method of fabricating reinforced composite members as claimed in claim 34 wherein the components are one of hollow components and integral skin cellular core components.

36. The method of fabricating reinforced composite members as claimed in claim 35 wherein the composite material is chosen from a group consisting of fiber reinforced polymer-matrix, fiber reinforced metal polymer composite and nano-composite.

37. The method of fabricating reinforced composite members as claimed in claim 36 wherein the composite material is applied to the assembly using one of a winding technique and a hand layup technique.

38. An internally supported composite member comprising;
a plurality of components having cross-sectional shapes arranged to form a predetermined cross sectional shape of the composite member, wherein at least one of the plurality of components is pre-stressed; and
an outer-shell of composite material.

39. The internally supported composite member as claimed in claim 38 wherein all of the plurality of components is pre-stressed.

40. The internally supported composite member as claimed in claim 39 wherein the composite material is chosen from a group consisting of fiber reinforced polymer-matrix, fiber reinforced metal polymer composite and nano-composite.

41. The internally supported composite member as claimed in claim 40 wherein outer-shell includes a plurality of layers and each of the plurality of layers has an orientation and wherein at least one of the layers has a different orientation from an adjacent layer.

42. The internally supported composite member as claimed in claim 41 wherein the component has a longitudinal axis and a lateral axis and at least one of the layers is oriented along the longitudinal axis and at least one of the layers is oriented along the lateral axis.

43. The internally supported composite member as claimed in claim 41 wherein the plurality of layers produce a composite layered pattern and the composite layered pattern has a predetermined thickness, a predetermined strength and a predetermined weight.

44. The internally supported composite member as claimed in claim 43 wherein the plurality of layers are oriented whereby there is at least one region on the components having no layers.

45. The internally supported composite member as claimed in claim 43 wherein the cross-sectional shapes of the components are chosen whereby when arranged to form the predetermined cross sectional shape provide internal support.

46. The internally supported composite member as claimed in claim 45 wherein the predetermined cross sectional shape is symmetrical around one of one axis and two axes.

47. The internally supported composite member as claimed in claim 38 wherein the cross-sectional shapes of the components are chosen whereby when arranged to form the predetermined cross sectional shape provide internal support.

48. The internally supported composite member as claimed in claim 47 wherein the predetermined cross sectional shape is symmetrical around one of one axis and two axes.

49. An internally supported composite member comprising:
an internal component having a predetermined cross section; and
an outer-shell of composite material having a plurality of layers and each of the plurality of layers has an orientation and wherein at least one of the layers has a different orientation from an adjacent layer.

50. The internally supported composite member as claimed in claim 49 wherein the composite member has a longitudinal axis and a lateral axis and at least one of the layers is oriented along the longitudinal axis and at least one of the layers is oriented along the lateral axis.

51. The internally supported composite member as claimed in claim 49 wherein the plurality of layers produce a composite layered pattern and the composite layered pattern has a predetermined thickness, a predetermined strength and a predetermined weight.

52. The internally supported composite member as claimed in claim 51 wherein the plurality of layers are oriented whereby there is at least one region on the internal components having no layers.

53. The internally supported composite member as claimed in claim 52 further including the step of cutting out a portion of the internal component in registration with at least one region having no layers thereon.

54. The internally supported composite member as claimed in claim 53 wherein the internal component is symmetrical around one of one axis and two axes.

55. The internally supported composite member as claimed in claim 49 wherein the internal component is one of a hollow component and an integral skin cellular core component.

56. The internally supported composite member as claimed in claim 49 wherein the composite material is chosen from a group consisting of fiber reinforced polymer-matrix, fiber reinforced metal polymer composite and nano-composite.

57. The internally supported composite member as claimed in claim 49 wherein the internal component is made from one of plastic and metal.
